(19) United States
(12) Patent Application Publication
(10) Pub. No.: US 2025/0233610 A1
(43) Pub. Date: Jul. 17, 2025

(54) IMPROVEMENTS IN IN-CAR WIRELESS COMMUNICATION

(71) Applicant: Harman Becker Automotive Systems GmbH, Karlsbad (DE)

(72) Inventor: Heiko Gernot Albert PANTHER, Berlin (DE)

(21) Appl. No.: 19/020,880

(22) Filed: Jan. 14, 2025

(30) Foreign Application Priority Data
Jan. 15, 2024 (DE) 102024101057.6

(51) Int. Cl. H04B 1/40; B60K 35/28; H01Q 5/25

(52) U.S. Cl. CPC H04B 1/40; B60K 35/28; H01Q 5/25

(57) ABSTRACT

It is herein disclosed an auxiliary wireless connectivity unit for an in-vehicle infotainment (IVI) system, comprising a plurality of (e.g. three or five) Bluetooth controllers, wherein the wireless connectivity unit is configured to connect to a domain controller of the IVI to provide additional wireless connectivity capabilities. UWB connection capability may additionally be included.

### CROSS REFERENCE TO RELATED APPLICATIONS

The present application claims priority to German Patent Application No. 102024101057.6, entitled “IMPROVEMENTS IN IN-CAR WIRELESS COMMUNICATION”, and filed on Jan. 15, 2024. The entire contents of the above-listed application(s) is hereby incorporated by reference for all purposes.

### TECHNICAL FIELD

Aspects of the present disclosure relate to an in-vehicle infotainment (IVI) system, and more particularly to improvements in near-field communication involving simultaneous data transmissions between multiple end-points inside an automobile.

### BACKGROUND

Vehicles comprising an in-vehicle infotainment (IVI) or in-car entertainment (ICE) system are well known. Traditionally, this means there are hardware such as processor(s) and stereo speaker(s) and software such as audio processing algorithms to enable music and other sounds to be played for the car occupants' benefit, for example. Since personal mobile devices become widespread, many IVIs have wireless communication capabilities to enable connections with mobile devices such as smartphones, tablets and computers, so that data such as music could be shared between a mobile device and the IVI, thus enabling the car's stereo system to play a track stored in the mobile device, for example. In this way, all occupants of the car can experience the same entertainment environment together.

Whilst this in-car infotainment system remains popular, it lacks flexibility and customisability which have come to be expected and valued in many areas of modern life. Many people are used to consuming media via their own personal audio hardware, such as headphones or ear buds, and prefer those to the car stereo system. At the same time, more than one occupants of a car may wish to share their respective music collections more freely. Options are limited in existing automobile infrastructure. There is a demand for IVIs that enhance both the communal in-car experience and personalisation often at the same time, in a user-friendly and integrated way.

Present IVI systems may comprise means for connecting to mobile devices wirelessly via Wi-Fi and Bluetooth (BT), for example. Bluetooth is conventionally known as a means of short-range communication in a personal area network, for data transmission in a personal capacity (e.g. between a smartphone and earphones that both belong to and travel with the same individual). Beyond this, Bluetooth is seldom used for data sharing interpersonally except on a simple scale, like pairing two smartphones and sharing a few photos between friends on an ad-hoc basis; users usually seek out other means when data need to be sent or obtained. Furthermore, in a multiple-user group setting involving three or more individual devices who want to share data in a convenient way, it is highly unusual for Bluetooth to be thought of as a plausible candidate for connectivity.

In a car, a Bluetooth controller/transceiver may be provided in an IVI, for connecting to one end-point i.e. mobile device at one time. This end-point may be a driver's personal audio device, for example, so he/she could listen to music and/or driving-related audio alerts using earphones instead of loudspeakers in the car space.

Even in more advanced Bluetooth protocols, in which several mobile devices may be allowed to be connected to the IVI simultaneously, data transfer can only happen between one of them and the Bluetooth controller of the IVI at one time. In other words, for example, as long as the driver's earphones are connected to the car IVI via Bluetooth and receiving audio data, another person in the car may not be able to tap into any data provided by the IVI via Bluetooth too. It is therefore not possible that two or more occupants of the car can listen to the same audio from the IVI using their respective headphones. It is also not possible for one occupant to connect his/her phone to the IVI and play his/her music library via the IVI's system, either for others to stream it to their own headphones using Bluetooth, or while the one Bluetooth controller is already occupied in data transmission with another end-point.

### SUMMARY

It is herein presented, for use in an IVI, a communication system employing multiple RF connections for use simultaneously. Multiple occupants in an automobile will be able to connect to the IVI, or to each other through the IVI, via Bluetooth, and preferably also ultra-wideband (UWB) (IEEE 802.15.4a). The system is able to support multiple end-points by employing a corresponding multiple number of Bluetooth controllers, preferably in addition to at least one UWB transceiver.

This allows an in-built “shareable” audio (or even video or multimedia) experience affording each occupant of the car (driver, passengers) the greatest flexibility to choose what to share and enjoy together or individually through the vehicle's IVI. They can enjoy together the same music through their headphones at a high volume while passing through a low-noise neighbourhood which prohibits the use of the car stereo loudspeakers. They can listen to music while choosing to additionally subscribe to different available audio streams, such as road condition alerts, guided driving directions, safety alerts, or any combination administered by the vehicle, without having to force the same single “sound stage”, with one setting, on all passengers and the driver.

In accordance with an aspect of the present invention, there is disclosed an (auxiliary) wireless connectivity unit for an in-vehicle infotainment (IVI) system, comprising a plurality of Bluetooth controllers/transceivers, wherein the wireless connectivity unit is configured to connect to a domain controller of the IVI to provide additional wireless connectivity capabilities. Preferably, the number of Bluetooth controllers/transceivers is at least three, and more preferably at least five.

Preferably, the wireless connectivity unit further includes an ultra wideband (UWB) transceiver. Preferably, the UWB transceiver is connected to and serviced via one of the plurality of Bluetooth controllers, preferably via a serial peripheral interface, SPI.

Preferably, each of the plurality of Bluetooth controllers is connected to a USB port of the auxiliary wireless connectivity unit.

The wireless connectivity unit optionally further comprises a plurality of multiplexers, each connected to the UWB transceiver and a respective one of the plurality of Bluetooth controllers.

In accordance with another aspect of the invention, there is disclosed an in-vehicle infotainment (IVI) or in-car entertainment (ICE) system, comprising the wireless connectivity unit mentioned above, and a domain controller configured to connect to the wireless connectivity unit.

Optionally, the IVI system further comprises a plurality of Bluetooth-enabled wearables each configured to connect to a respective one of the plurality of Bluetooth controllers; the wearables are for example headphones (or headsets, earbuds, etc.).

Preferably, the wireless connectivity unit is connectable to, but is physically separate from the domain controller (e.g. they are located in different areas of the vehicle). Preferably, the domain controller contains processing means to carry out audio signal processing and to output audio data via the plurality of Bluetooth controllers of the auxiliary wireless connectivity unit.

Preferably, the domain controller connects to the auxiliary wireless connectivity unit via USB connection using the USB port of the auxiliary wireless connectivity unit.

Preferably, the domain controller contains a multiple number N of modules for spatialising, ducking and mixing audio data from a plurality of sources of audio data, wherein N is equal or greater than the number of Bluetooth controllers of the auxiliary wireless connectivity unit.

Optionally, the sources of audio data comprise at least two of: in-car communication data or phone-call sharing data; vehicle prompts or notifications; emergency vehicle detection (EVD)-related messages; native media sources of the domain processor; audio from a microphone connected to the domain controller; and own media content or pushed content associated with a mobile device connected to the auxiliary wireless connectivity unit via Bluetooth.

Optionally, the domain controller is also adapted to connect to one or more wired in-vehicle speaker(s), and comprises a module for spatialising, ducking and/or mixing audio data for output to the wired in-vehicle speaker(s).

Preferably, the IVI is able to automatically select to output data using either Bluetooth connectivity or an alternative connectivity mode such as UWB.

In accordance with another aspect of the invention, there is disclosed a vehicle comprising the aforementioned wireless connectivity unit or the aforementioned in-vehicle infotainment (IVI) system.

In order that the present invention be more readily understood, various aspects of specific embodiments will now be described in conjunction with the attached drawings.

### BRIEF DESCRIPTION OF THE DRAWINGS

FIG. 1 is a schematic diagram of a car with an in-vehicle infotainment (IVI) system in accordance with one or more embodiments of the invention.

FIG. 2 is a block diagram illustrating parts of the IVI system of FIG. 1.

FIG. 3 is a block diagram illustrating audio signal flow in a wireless connectivity unit in an IVI system in accordance with one or more embodiments of the invention.

FIGS. 4A and 4B are schematic diagrams illustrating two use cases of the IVI system in accordance with one or more embodiments of the invention.

### DETAILED DESCRIPTION OF THE PREFERRED EMBODIMENTS

Various aspects of the invention are described below.

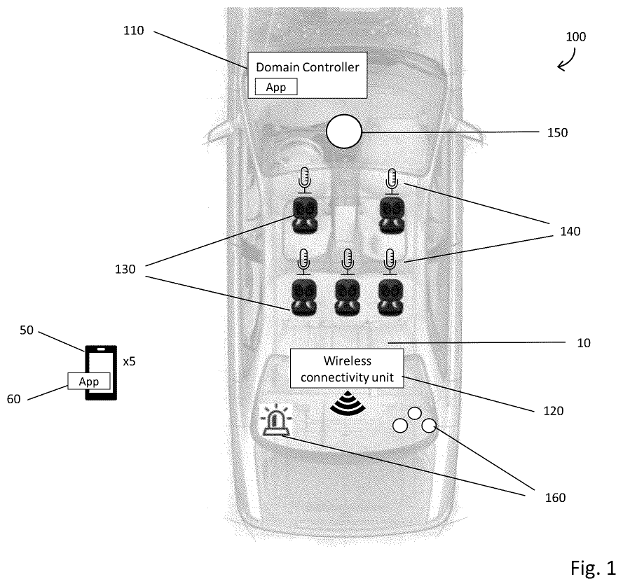

An exemplary car audio system or IVI/ICE system 100 is illustrated in FIG. 1. The space or cabin 10 inside the car, which has five seats (one driver's seat, one front passenger seat, three rear passenger seats), can be thought of comprising five corresponding personal audio zones. The number of car seats and zones can be different, but are multiple and preferably three or above, more preferably five or above. FIG. 1 is a schematic diagram; the locations of different elements of the IVI shown are not meant to be in any way limiting and can be changed.

The IVI preferably includes a domain controller 110 and a wireless connectivity unit 120.

Each personal audio zone has its own associated wearable(s), for example wireless headphones (this could be any wearable loudspeakers with or without microphones, such as earpieces, earbuds, headsets, but will chiefly be referred to as “headphones” below) that are equipped with Bluetooth capability, preferably in additional to alternative connectivity capabilities. These wearables 130 are intended to connect (pair) with Bluetooth controllers provided as part of the IVI (explained below). Preferably, the headphones 130 are provided as part of the IVI 100 (i.e. they come with the car 10 as sold to the consumer, alongside wired in-car speakers and audio processors).

Alternatively, headphones are not an integral part of the IVI, and the latter is intended to work with headphones brought in by the users (occupants of the car). In either case, users can bring their own headphones and have them connected to the IVI. If brought-in headphones do not support Bluetooth, they may be connected to the IVI via an alternative RF connectivity mode, for example UWB.

Each personal sound zone may be provided with sound-receiving means such as a microphone 140 (wired, i.e. non-wirelessly connected). This may be used for facilitating in-car communication (such as among driver/passengers), and/or receiving spoken commands to the computing system (in relation to the IVI or otherwise) of the car, for instance.

Each personal sound zone may have a mobile device 50 assigned. This is preferably the user's own personal device. In one preferable aspect, a companion app 60 may be available and downloaded to that device, providing a user interface for configuration and/or personalisation of the user's own audio/infotainment experience, for example to select or subscribe to one or more audio streams available in the system.

Example audio/media sources include:
own media content or pushed content;
in-car communication (ICC) or phone-call sharing, involving multiple mobile devices;
vehicle prompts and notifications (e.g. turn signals, seatbelt warnings);
emergency vehicle detection (EVD)-related alerts and messages;
native IVI media sources.

Different devices may subscribe to different combinations of sounds sources/streams of the system. For example, only the driver receives certain types of sounds like road condition alerts. On the other hand, for example, the driver may not be allowed to disable seating-belt warning alerts (according to legally mandated requirements in different territories, for example; some may be manufacturer mandated and not customisable).

Media access may include a publish/subscribe model: content is published from one device, and can be subscribed to by other devices.

Instructions input in the companion app are received by a corresponding app or module residing in the domain controller. The provision of the app as a manner of user control of the IVI is optional.

The IVI optionally comprises one or more (wired) cabin speaker(s) and/or amplifier(s) 150 such as a centre-channel speaker, which are independent of the sound zones in the car cabin.

There may be provided an external microphone array and EVD processing means 160, which may be related to the provision of audio warnings, alerts, messages etc. in relation to EVD.

The domain controller 110 of the IVI, also known as an audio head unit, comprises hardware and software (e.g. processors, microprocessors, controllers, memory, code and algorithms stored in memory) responsible for carrying out the audio processing required in the operation of in-car infotainment.

The wireless connectivity unit 120 of the IVI is connected to the domain controller 110, and introduces additional connectivity capabilities to the IVI that the domain controller does not provide. It can therefore be considered an auxiliary (or supplementary, or subsidiary) wireless connectivity unit or module. As it is intended for use in an IVI to allow multiple mobile devices or wearables to connect to the IVI/domain controller to receive and/or transmit audio, it may also be called a wireless audio unit.

The auxiliary wireless connectivity unit is preferably a Hi-Fi (high-fidelity) low-latency hub. In accordance with one or more embodiments of the present invention, the auxiliary wireless connectivity unit contains multiple transceivers/antennas for Bluetooth. It is particularly preferred that it further contains at least one other RF technology, such as UWB, thus implementing a communication system with multiple RF technologies (multiple/redundant Bluetooth connections plus UWB).

The auxiliary wireless connectivity unit is preferably located away from the domain controller/central processing module, because there may not be enough physical space in the domain controller to physically accommodate the multiple antennas; a design/manufacture limitation is thus removed. In this sense, the auxiliary wireless connectivity unit can be considered as a RF subsystem or “break-out” box, although it is intended to be fixedly installed as part of the vehicle's/IVI's infrastructure. It means that the wireless connectivity unit with its additional Bluetooth or other transceivers could be retrofitted into an existing domain controller, IVI, car, or designs thereof, without having to (significantly) modify any of them, in order to introduce the technical advantages associated with the presently disclosed wireless connectivity module. This aspect also ensures or improves performance, in that the location of the wireless connectivity module in the car can be more flexibly determined, for example based on the expected or actual RF reception quality in different spots in the car. This also avoids the domain controller having to undergo a technical approval process again after changes in components (re-homologation).

Alternatively, the auxiliary wireless connectivity unit or its components may be joined to or part of the domain controller.

The number of personal audio zones in this example is five, corresponding to the number of seats in the car cabin illustrated in FIG. 1. This example is included only for illustration purposes. The number of zones and corresponding number of wearables, microphones etc. could be any multiple number, preferably at least three, more preferably at least four, more preferably at least five.

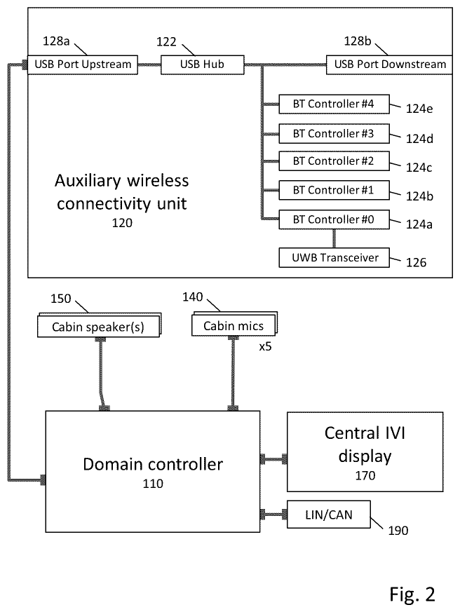

FIG. 2 is a block diagram illustrating parts of an exemplary IVI. There is provided a domain controller 110.

The domain controller 110 is preferably connected to one or more of:
a central display 170 of the IVI;
one or more cabin speaker(s) 150;
cabin microphones 140 (five in this example corresponding to five seats).

The central display 170 may for example have 1920×1080 resolution and 60 Hz refresh rate.

Preferably, the domain controller is provided with LIN/CAN serial communication protocols 190.

The microphones 140 may be connected to the domain controller via A2B (automotive audio bus) connections. The cabin microphones are particularly desirable when reduced latency during in-car communication use is needed or preferred.

The auxiliary wireless connectivity unit 120 has USB ports upstream 128a and downstream 128b connected to an internal USB hub 122. USB is the native host interface for Bluetooth (BT) controllers. When in use, the wireless connectivity unit is connected by USB to the domain controller 110 via the USB upstream port 128a. Connected to the USB hub, in the wireless connectivity unit, are multiple Bluetooth controller-transceivers 124, i.e. each Bluetooth controller is connected via USB to the hub. The number of BT controllers are multiple (more than one, preferably at least three, more preferably at least four, more preferably at least five), and preferably corresponds to the number of personal audio zones designated in the vehicle 10. For example, there are five BT controllers 124a-e. One of these may be a primary BT controller 124a.

The wireless connectivity unit 120 also preferably comprises UWB (ultra wide band) connectivity, via at least one UWB controller/transceiver 126. In accordance with the presently described example, there is exactly one USB transceiver, as shown in FIG. 2. Preferably, the UWB transceiver 126 is connected to and serviced by the primary BT controller 124a, for example using an SPI (serial peripheral interface). Alternatively, it may be connected to another BT controller 124b/c/d/e, or connected to another (non-BT) controller/microcontroller, or connected to the USB hub 122 directly. The USB connections are preferably USB 2.0 connections.

Control of proprietary headphone functions can be enabled via Bluetooth connectivity. Brought-in headphones (taken into the car environment by a user) can be supported. Head orientation data, provided by a headset IMU (inertial measurement unit) can also be received and supported by the IVI. The multiple Bluetooth controllers can also provide backup mobile phone connections when desired. The Bluetooth controllers may be depopulated for cost optimisation when necessary.

UWB is preferably provided in addition to Bluetooth, and is particularly favoured to achieve minimum latency when this is needed or preferred. In the present context UWB can achieve <10 ms latency end-to-end, preferred for a more natural communication experience for the human users. For example, 500 MHz channels in the 6.5 to 9 GHz band are used.

A potential use for the USB downstream port 128b is for TCU and/or GNSS (Global Navigation Satellite System).

The domain controller 110 comprises digital signal processing (DSP) means. It is used for all DSP, which may include, for example, voice sensing volume fading (VSVF) used in in-car communication, and spatialiser technology used to create, and place sound sources on, one or more personal sound stages in the vehicle.

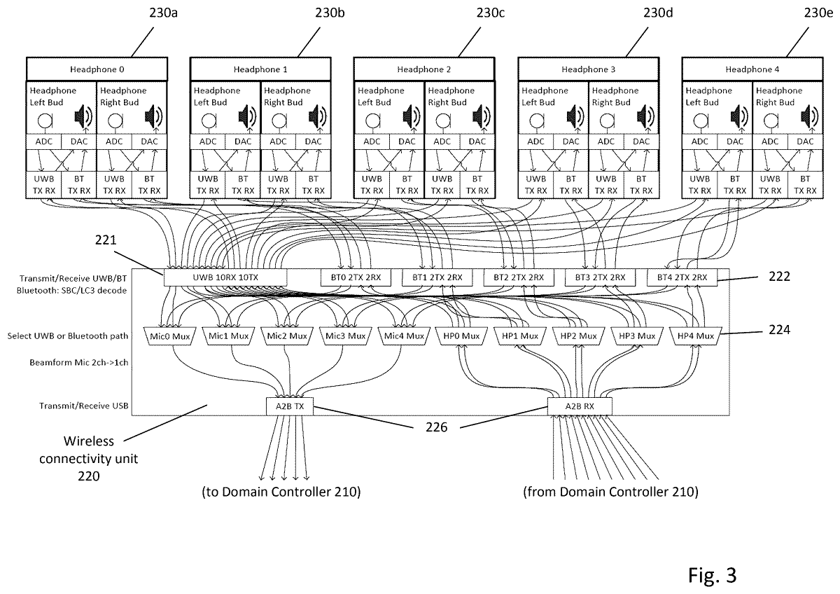

FIG. 3 shows, in accordance with one or more embodiments of the present invention, audio paths in relation to an auxiliary wireless connection module in an in-car audio system represented by arrows connecting different radios, components and end points. Control paths are not shown.

The wearables (e.g. headphones, earbuds, headsets) are able to communicate with the IVI preferably via two alternative RF connections implemented in the system.

Multiple headphones 230a-e are represented in the upper part of FIG. 3. In this diagram, each of the five headphones (e.g. earbuds or headsets) appears identical to each other. There is provided a left bud and right bud with associated analog-to-digital converters (ADCs) and digital-to-analog converters (DACs). Each headphone unit is provided with a Bluetooth (BT) transmitter (TX) and BT receiver (RX) i.e. BT transceiver. Preferably, each is also provided with a UWB transmitter (TX) and UWB receiver (RX) i.e. UWB transceiver. These transceivers are appropriately connected to the ADC and DAC as indicated by the arrows in FIG. 3.

The auxiliary wireless connectivity module 220 is represented in the lower part of FIG. 3. It is a connectivity module that wirelessly connects the wired audio from the domain controller 210 to the wireless headphones. The aforementioned UWB TX-RX and BT TX-RX of respective headphones are connectable to the UWB transceiver(s) and BT transceivers in the wireless connectivity module 220. In this example, the wireless connectivity module comprises five BT controllers/transceivers (including antennae) 222 each with 2 TX and 2 RX for left and right channels. There is also one UWB transceiver 221 with 10 RX and 10 TX channels. Alternatively, multiple UWB transceivers can be provided, or none at all.

The transceivers communicate with multiplexers (MUX) 224. Multiplexers are responsible for selecting/switching the audio routes to be used (i.e. selecting the sources and destinations) in each case-either UWB or BT. Preferably, the system is able to automatically select which RF technology to use based on the abilities of the available endpoints, without user intervention. This can be done by the wireless connectivity unit directly. Alternatively, it is implemented by application(s)/algorithm(s) running in the domain controller, or in another part of the IVI system. For example, connectivity defaults to using UWB if present, and if not, BT is used instead in a BT-enabled headphone. In the current example, there are five multiplexers corresponding to microphones of the headphones and five multiplexers corresponding to loudspeakers of the headphones. The microphone MUXes are connected to A2B buses (TX and RX) 226.

The domain controller 210 (not illustrated) receives signals from these A2B buses, as represented by the arrows at the bottom of FIG. 3. The domain controller preferably comprises control means for each of the personal sound zones in the car; such means may comprise a spatialiser, ducker and mixer or at least one thereof, i.e. audio processing means. There is preferably also control means for other components of the IVI such as in-car wired speaker(s). These control means are directly or indirectly connected to and receive input from audio sources, such as brought-in devices and domain controller internal sources (e.g. tuner), cabin microphones, and the A2B RX bus(es) which receive audio data from the wireless connectivity module 220 and thus the headphones 230a-e, and can digitally process and mix the audio data. The control means are also connected to and provide output to amplifiers corresponding to the cabin speakers, for example, and the A2B TX bus(es) which send audio data to the wireless connectivity module and onward to the headphones.

All audio paths except Bluetooth preferably comprise uncompressed PCM (pulse-code modulation) signals.

Exemplary headphone audio rates can be 48 kHz/16b (stereo) and 32 kHz/16b (mic).

Wi-Fi functionality (and/or another type of IP connectivity) and corresponding transceiver(s)/controller(s) is preferably provided in the domain controller.

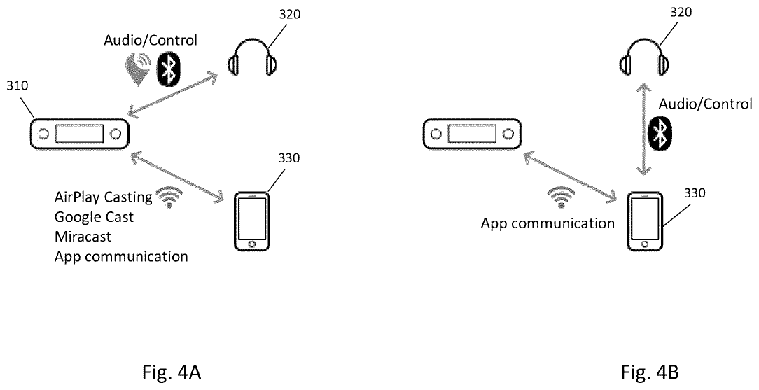

FIGS. 4A and 4B illustrate what connectivity methods are used for what devices/purposes, according to two different scenarios in accordance with one or more embodiments of the present disclosure.

FIG. 4A is a main/default use case. The headsets 320 are connected via BT or UWB to the IVI using the wireless connectivity module 310, while a personal mobile device 330 such as a smartphone is connected to the IVI via Wi-Fi, using, for example, AirPlay Casting, Google Case, Miracast, and other app communication.

FIG. 4B is a fallback or telephony use case. The mobile device 330 such as a smartphone is connected to the IVI via Wi-Fi for app communication, while the headset 320 simply communicates with the mobile device via Bluetooth pairing therewith, without going through the car's IVI.

Alternatively, another type of IP connection other than Wi-Fi may be used for casting.

The present disclosure thus provides a user-friendly, fully integrated, headphone-centric IVI experience, as multiple audio streaming applications of multiple (e.g. at least five) end-point devices are supported simultaneously, in contrast to known IVI systems. Multiple users can therefore bring their own headphone/smartphone ecosystems into the car and be connected conveniently and seamlessly to respective in-car personal zones, and each of them can hear all the necessary or preferred sounds and communications, whilst still being able to enjoy a full music/multimedia experience, in a truly personalised way. The car is as easy to connect to and interact with as one's mobile device, and a high degree of freedom is provided.

The present invention is not to be limited by the above-described aspects and embodiments, and that many variations are within the scope of the appended claims. The various aspects and embodiments may be combined if necessary and appropriate. The drawings serve as exemplary illustrations of the invention only, to aid understanding of the invention.

1. An auxiliary wireless connectivity unit for an in-vehicle infotainment, IVI, system, comprising a plurality of Bluetooth controllers, wherein the auxiliary wireless connectivity unit is configured to connect to a domain controller of the IVI to provide additional wireless connectivity capabilities.

2. The auxiliary wireless connectivity unit according to claim 1, wherein the plurality of Bluetooth controllers comprise three or more Bluetooth controllers.

3. The auxiliary wireless connectivity unit according to claim 2, wherein the plurality of Bluetooth controllers comprise five or more Bluetooth controllers.

4. The auxiliary wireless connectivity unit according to claim 1, further comprising an ultra wideband, UWB, transceiver.

5. The auxiliary wireless connectivity unit according to claim 4, wherein the ultra wideband, UWB transceiver is connected to and serviced via one of the plurality of Bluetooth controllers.

6. The auxiliary wireless connectivity unit according to claim 5, wherein the ultra wideband, UWB transceiver is connected to the one of the plurality of Bluetooth controllers via a serial peripheral interface, SPI.

7. The auxiliary wireless connectivity unit according to claim 1, wherein each of the plurality of Bluetooth controllers is connected to a USB port of the auxiliary wireless connectivity unit.

8. The auxiliary wireless connectivity unit according to claim 5, further comprising a plurality of multiplexers, wherein each of the plurality of multiplexers is connected to the ultra wideband, UWB transceiver and a respective one of the plurality of Bluetooth controllers.

9. An in-vehicle infotainment, IVI, system, comprising: the auxiliary wireless connectivity unit in accordance of claim 1, and the domain controller configured to connect to the auxiliary wireless connectivity unit.

10. The IVI system according to claim 9, further comprising a plurality of Bluetooth-enabled wearables each configured to connect to a respective one of the plurality of Bluetooth controllers, wherein the wearables are preferably headphones.

11. The IVI according to claim 9, wherein the auxiliary wireless connectivity unit is adapted to connect to but is separate from the domain controller, and wherein the domain controller comprises processing means to carry out audio signal processing and to output audio data via the plurality of Bluetooth controllers of the auxiliary wireless connectivity unit.

12. The IVI according to claim 11, wherein the domain controller connects to the auxiliary wireless connectivity unit via USB connection using the USB port of the auxiliary wireless connectivity unit.

13. The IVI according to claim 11, wherein the domain controller comprises a multiple number N of modules for spatialising, ducking and mixing audio data from a plurality of sources of audio data, wherein N is equal or greater than the number of Bluetooth controllers of the auxiliary wireless connectivity unit.

14. The IVI according to claim 11, wherein the IVI is able to automatically select to output data using either Bluetooth connectivity or an alternative connectivity mode.

15. A vehicle comprising the wireless connectivity module according to claim 1.
